(19) United States
(12) Patent Application Publication
(10) Pub. No.: US 2025/0252422 A1
(43) Pub. Date: Aug. 7, 2025

(54) DONOR MANAGEMENT SERVICE

(71) Applicant: GRAVVY, INC., Middletown, DE (US)

(72) Inventors: Gary Tsifrin, San Francisco, CA (US); Francesca Wong, San Francisco, CA (US); Adam Klein, Oakland, CA (US); Steve Barretto, Oakland, CA (US); Jamie Zirkle, Oakland, CA (US); David Geisinger, San Diego, CA (US)

(21) Appl. No.: 19/041,906

(22) Filed: Jan. 30, 2025

Related U.S. Application Data
(63) Continuation of application No. 18/095,470, filed on Jan. 10, 2023, now abandoned.
(60) Provisional application No. 63/298,520, filed on Jan. 11, 2022.

(51) Int. Cl. G06Q 20/32; G06Q 30/0226

(52) U.S. Cl. CPC G06Q 20/325; G06Q 30/0233

(57) ABSTRACT

A network computer system records deposits to a donation funding account that is shared amongst a plurality of users. The donation funding account includes a total fund that is based on the recorded deposits for the plurality of users. The network computer system maintains an allocation profile for each of the plurality of users, where the allocation profile identifies, for each user, one or more user-selected organization recipients and an allocation of a portion of the total fund that is attributable to that user. In response to a given event, the network computer system automatically generates an output such as a donation acknowledgment report, based on the allocation profile specified by the respective user. The described by various examples, the output can be in the form of a visual representation and/or report.

### RELATED APPLICATIONS

This application is a continuation of U.S. patent application Ser. No. 18/095,470, filed Jan. 10, 2023, which claims benefit of priority to Provisional U.S. Patent Application No. 63/298,520, filed Jan. 11, 2022; the aforementioned priority applications being hereby incorporated by reference in their respective entireties.

### BACKGROUND

Affiliate marketing programs exist to provide user with rewards (e.g., “cash back awards”). Typically, users earn awards through the online and commerce activities. Affiliate marketing programs are sometimes implemented in network computer systems through a collection of computer-implemented processes which identify transactions which qualify for affiliate marketing programs.

### BRIEF DESCRIPTION OF DRAWINGS

FIG. 1 illustrates a network computer system for implementing a donation management service, according to one or more examples.

FIG. 2 illustrates a method to operate a network computer system to provide a donation management service, according to one or more embodiments.

FIG. 3A through FIG. 3C illustrate examples of output content which can be generated by network computer system 100, according to one or more examples.

FIG. 4 illustrates an example network computer system on which one or more embodiments are implemented.

### DETAILED DESCRIPTION

A network computer system records deposits to a donation funding account that is shared amongst a plurality of users. The donation funding account includes a total fund that is based on the recorded deposits for the plurality of users. The network computer system maintains an allocation profile for each of the plurality of users, where the allocation profile identifies, for each user, one or more user-selected organization recipients and an allocation of a portion of the total fund that is attributable to that user. In response to a given event, the network computer system automatically generates an output such as a donation acknowledgment report, based on the allocation profile specified by the respective user. The described by various examples, the output can be in the form of a visual representation and/or report.

One or more examples described provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

One or more examples described can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some examples described can generally require the use of computing devices, including processing and memory resources. For example, one or more examples described may be implemented, in whole or in part, on computing devices such as servers, desktop computers, cellular or smartphones, and tablet devices. Memory, processing, and network resources may all be used in connection with the establishment, use, or performance of any example described herein (including with the performance of any method or with the implementation of any system).

Furthermore, one or more examples described may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

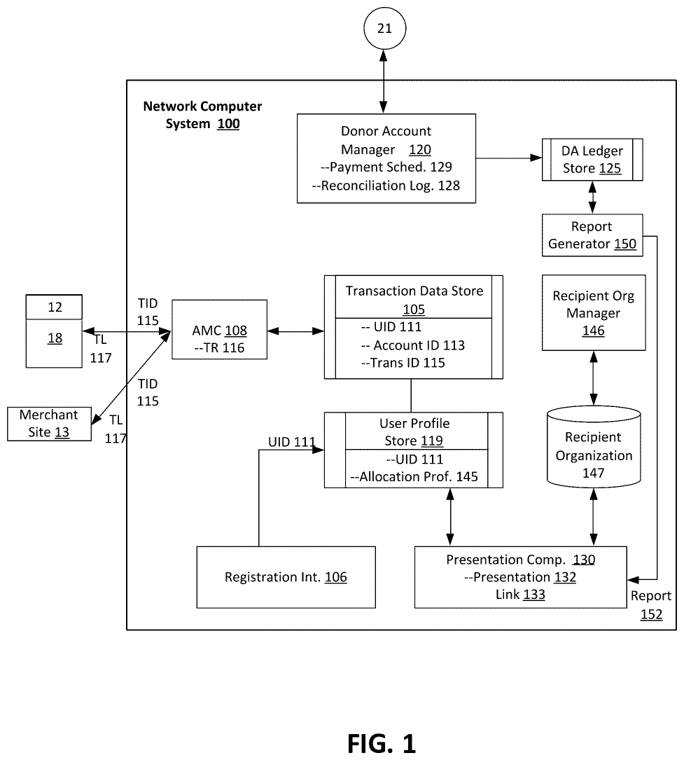

FIG. 1 illustrates a network computer system for implementing a donation management service, according to one or more examples. In examples, the system 100 is provided in connection with one or more affiliate marketing services where a user can receive a monetary reward (e.g., cashback) for completing a purchase. As described, the monetary awards which individual users receive can be directly or indirectly deposited into the donation funding account 21 that is managed through the system 100. Examples as described with FIG. 1 can be implemented in connection with a donation funding account 21. The donation funding account 21 can be established as an account that belongs or is otherwise associated with an entity that is legally permitted to (i) collect funds from individuals, (ii) distribute funds from multiple individuals in aggregate, and (iii) declare one or more exemptions with regards to receipt and/or payment of funds, where the exemptions pertain to the payment of taxes. In some examples, the donation funding account 21 belongs to, or is otherwise associated with an entity (e.g., organization, trust, association, etc.) that is established or otherwise operates under 26 USC § 501(c)(3) of the United States code. As described with various examples, the donation funding account 21 can receive deposits from multiple users of the donation management service. In variations, the system 100 provides multiple donor accounts 21, such as an individual donation funding account 21 for each user of the donation management service.

According to examples, a network computer system 100 includes an affiliate marketing component (AMC) 108, a donor account manager 120, a presentation component 130, and a report generator 150. The AMC 108 implements processes to enable the users of the donation management service to direct (or deposit) rewards received through participation in an associated affiliate marketing program to donation funding account 21. The donor account manager 120 tracks activities (e.g., withdrawals and deposits) performed with respect to the donation funding account 21, and further attributes account activities to individual users of the system 100. The presentation component 130 generates a presentation that visually represents characteristics, priorities or other attributes of a user's donation activities and plans. Additionally, the report generator 150 generates a report 155 that reflects charitable contributions that can be attributed to individual users.

### User Registration

In examples, the system 100 includes a registration interface 106 to enable individual users to register with the donor management service. For each user, the registration interface 106 generates a user identifier (UID 111) that is associated with the user's service account with the system 100. The UID 111 can uniquely identify the user with respect to the network computer system 100. The UID 111 is stored as part of a user profile store 119.

### Affiliate Marketing Component

The AMC 108 implements operations to provide or make affiliate marketing programs available to users of the system 100, such that rewards which users receive are deposited in the donation funding account 21. In examples, the AMC 108 enables rewards which the user receives to be automatically deposited in the donation funding account 21 and attributed to the user. The AMC 108 further includes processes that record user transactions which trigger rewards under an affiliate marketing program provided through AMC 108.

In some examples, the system 100 automatically enroll the user in an affiliate marketing program that is provided by, through or in affiliation with the system 100. In some examples, the AMC 108 utilizes a user account identifier 113 that is linked to the UID 111 to track the activities of the user. The account identifier 113 can correspond to, for example, a device or session identifier that is associated with the user device and/or the UID 111. For example, the account identifier 113 can be implemented as a cookie which is downloaded onto the user's computer when the user operates a browser or mobile device to login to the system 100 (e.g., user logs into a website for the donation management service or opens a service application (or “app”) for the system 100). In variations, a browser plugin or extension can generate a code or link that includes the account identifier 113. Still further, the account identifier 113 can correspond to a login credential or passcode that is manually or programmatically entered with a merchant site.

In some examples, an affiliated merchant site can automatically receive the account identifier 113, and then link a subsequent transaction (e.g., purchase) which the user makes to the account identifier. A transaction identifier 115 can be generated for a qualified transaction (e.g., a transaction which is completed with a merchant under affiliate marketing rules in connection with the system 100), where the transaction identifier 115 is linked to the account identifier of the user. For example, the affiliated merchant site may generate a transaction identifier 115 that is associated or otherwise based on the account identifier 113 of the user.

The AMC 108 can include processes that retrieve or receive transaction identifiers 115 that individual users complete with merchants of an affiliate marketing program. The AMC 108 can record information about each transaction in a transaction data store 105, where the recorded information identifies, for each user, the UID 111, the account identifier 113, and the transaction identifier 115 of each completed transaction.

In some variations, the AMC 108 generates or otherwise handles transaction links 117 which are communicated to a user device 18 in connection with the user providing input towards completion of a transaction. For example, the merchant site can detect or recognize the account identifier 113 of the user device 18, which the merchant site uses to link the user or computing device to a corresponding affiliate marketing program. The merchant site can generate a transaction link 117 which the user selects to complete a transaction. The transaction link 117 causes the user device 18 or merchant site 13 to communicate the transaction identifier 115, along with the account identifier 113, for the transaction which the user completes. In other examples, the merchant site 13 can directly, or indirectly through scripts embedded in content published onto the user account, call the AMC 108 to retrieve a transaction link 117 for the user as the user performs an action (e.g., select “purchase” button) to complete a given transaction. When the user completes the transaction, the user device 18 communicates to the AMC 108 that the transaction is complete, and the AMC 108 records a transaction identifier 115 for the completed transaction, along with the account identifier 113 and UID 111, as a record in the transaction data store 105.

In some examples, the system 100 communicates with a program, component or application (“user component 12”) running on a user device 18 to detect when the user initiates a transaction with an affiliate merchant. By way of example, the user component 12 can include a browser, browser extension, or browser plugin. In variations, the user component 12 can include a mobile application.

In examples, the AMC 108 communicates with the user component 12 to associate the UID 111 or account identifier 113 with transactions which the user initiates at an affiliate merchant site. The user component 12 can communicate with the AMC 108 to determine the affiliate merchant sites, brands, or products or services which are part of the hosted affiliated marketing program. The AMC 108 can, for example, maintain a list of affiliate merchants and/or merchant sites that is communicated to the user component 12 and updated over time. Alternatively, the user component 12 is operable to detect when the user is performing a particular type of activity that could be subject to an affiliate program. In response to detecting the activity, the user component 12 sends a request to the AMC 108 to determine whether the particular merchant or merchant site is part of the affiliate merchant program hosted by the system 100. Still further, the merchants and merchant products that are part of the affiliate merchant program can be hosted at one site, such that any transaction conducted by the user is presumed to be in connection with the affiliate award program hosted through the system 100.

In some examples, AMC 108 enables the user component 12 to identify or determine the UID 111 for individual users when those users conduct transactions with affiliates. The AMC 108 can, for example, structure the UID 111 or account identifier 113 so that it resides on the user device 18 as a persistent tracking identifier (e.g., session cookie). Alternatively, the AMC 108 can communicate the UID 111 or account identifier 113 to the user component 12 to cause, for example, the user component 12 to store the respective user identifier(s) on the user device 18, in advance of the user taking steps to complete a transaction using the computing device. Still further, the user can manually link the user component 12, the user's computing device or the user's payment instrument with a merchant site or store, such that subsequent transactions completed by the user are automatically associated with an affiliated marketing program of the system 100.

In other examples, when the user completes a transaction, the user component 12 communicates information about the transaction back to the AMC 108. The communicated information includes the transaction identifier 115, which can include merchant information, the date and time of the transaction, the amount of the transaction, and other relevant information associated with the affiliated award program. Still further, the communicated information can associate a user's transaction with the user account identifier 113 and/or UID 111. The AMC 108 records the information received in connection with each transaction with the transaction data store 105.

In other examples, the AMC 108 can determine information about user transactions with affiliate merchants through a variety of mechanisms. In some variations, a user can register an email address with the system 100, where the specified email address is one which the user elects to receive receipts and other communications from affiliate merchants. The user can forward emails from affiliate merchants to a designated address associated with the AMC 108 in order to identify a reward payment that is to be made to the donation funding account 21 on behalf of the user. The AMC 108 can further include processes to parse and analyze the emails to identify transaction information, including the UID 111 and/or account identifier 113 associated with the email, as well as the transaction identifier 115 and other information (e.g., merchant, item purchased, amount of award, rules or estimate date of award, etc.). The AMC 108 may populate records to record individual transactions with transaction data store 105, with each transaction being identified and linked to a particular user.

As an addition or variation, the AMC 108 can access webpages or account pages of merchants or affiliate marketing program where completed transactions and reward information is maintained. The AMC 108 can, for example, use programmatic connectors or scrapers to access web pages and network sites where affiliate merchants record transactions. The transaction information can be retrieved for individual users and recorded with the transaction data store 105.

### Affiliate Program Award Tracking

In examples, the AMC 108 includes tracking logic 116 that maintains a set of rules for an affiliate award program, merchant and/or program. The AMC 108 can implement tracking logic 116 to monitor transactions recorded with the transaction data store 105. The recorded transactions can be monitored as to the timing of issuance of a reward in relations to when a corresponding transaction is completed. The timing of the issuance of the reward can vary based on, for example, the merchant's return policy for the award. The tracking logic 116 can determine estimated deposit dates for affiliate rewards, based on the dates of the recorded transactions, as well as transaction-specific rules associated with the recorded transactions (e.g., award is canceled if product is returned before X days). In some examples, the AMC 108 can further implement the tracking logic 116 to update a donor ledger 125 to reflect an anticipated date of deposit for an affiliate award of the recorded transaction.

Indirect Affiliate Award Deposits (Withdrawal from User Account)

While some examples provide for the donation funding account 21 to directly receive funds distributed under an affiliate marketing program, in variations, the funds representing the user awards can be received by actions of the user. In an implementation, rewards under an affiliate marketing program can be received in personal accounts (e.g., checking, credit card) of individual users. The AMC 108 can implement one or more processes to access personal user funding accounts (“user account program interface 118”), such as user's credit card, checking or savings accounts, in order to identify reward payments which the user receives under the affiliate award program of the system 100. In such implementations, the user identifies personal funding accounts through the registration interface 106. For example, the user can provide input that identifies the user's login credentials with a particular financial institution. Further, the AMC 108 can include program connectors or interfaces with online financial accounts of the user, in order to use the user's login credentials to access accounts resources (e.g., an accounts webpage) of the user's account. The AMC 108 can scrape and/or parse transaction information provided on the user's account page to identify deposits from merchants or sources of affiliate award payments. When such deposits are identified, the AMC 108 can tally the payments and provide the user with a report or notification of such deposits from the affiliate marketing program rewards. The user can elect to initiate payment of some or all of the reward payments from the user's financial account(s) to the donation funding account 21.

### Recipient Organization Management

In some examples, the system 100 includes a recipient organization manager 146 that maintains a data store of recipient organizations (“recipient organization data store 147”), where each listed recipient organization is an organization that is eligible to receive payment from donation funding account 21. The recipient organization manager 146 can implement processes to access and inspect public records (e.g., IRS records, websites of organizations, etc.) to verify, for example, that a particular organization is eligible to receive donations as a charitable nonprofit. As an addition or variation, the recipient organization manager 146 can determine a legal category or type for organizations that can receive payment from the donation funding account 21 (e.g., political action organization versus charitable non-profit). Still further, the recipient organization manager 146 can categorize and label organizations by subject, topic, location or popularity. Still further, recipient organization manager 146 can implement processes to identify content-such as imagery (e.g., image files on website of organization) that are associated with a particular recipient organization. In this way, recipient organization manager 146 can associate identifiers for individual recipient organizations with legal designations (e.g., verified charitable organization, political organization), topical categorizations and imagery.

Additionally, in variations, recipient organization manager 146 can associate charitable organizations with particular individuals or users who have made contributions or otherwise sponsor the organization. Still further, recipient organization manager 146 can tally the total number of donations made through the system 100 to individual recipient organizations, as well as the total number of donors, and/or demographic categories or information regarding individuals who specify the particular organization in their profile. Based on the tallied information, recipient organization manager 146 can identify, for example, recipient organizations that are increasing in popularity, or organizations that are popular in a given geographic region.

While some examples provide for users to specify recipient organizations, in variations, users of the system 100 can interact with the system 100 to specify organizations by category. For example, the user can specify an allocation to “animal shelter” organizations, and recipient organization manager 146 can then select one or more recipient organizations for the user. As another example, recipient organization manager 146 can generate a list of popular charities, or popular charities by category, and display the list through the presentation component 130. In this way, the user can provide input for the allocation profile.

### Allocation Profiles

The system 100 can maintain an allocation profile 145 for each user. For each user, the allocation profile 145 indicates (i) one or more recipient organizations (e.g., charities) that the user wishes to make monetary contribution to, and (ii) an amount that each recipient organization is to receive. The user can indicate the amount that each recipient is to receive as a weight or proportion value as compared to the total amount of award payments which the user expects or has received and/or the amount which the user plans to donate. For example, the user's allocation profile 145 can identify a list of recipient organizations, each of which are associated with a percentage or decimal value that reflects the user's preference as to the proportional value or allocation that each recipient organization should receive, as compared to the total amount of payments which are made from the donor account on behalf of the user.

The presentation component 130 can include features to enable users to access information stored with the recipient organization manager 146. For example, the presentation component 130 may include search and browse features to enable users to perform search and browse operations to identify eligible recipient organizations who can receive reward payments. In particular, individual users interact with presentation component 130 to specify input for determining their allocation profile 145.

### Deposits

Depending on implementation, different mechanisms can be used to deposit reward payments into the donation funding account 21. As described with some examples, donation funding account 21 may receive payments electronically, directly from a merchant or source of a reward payment that is attributed to a particular user. In some implementations, once a given user can completes a transaction under an affiliate merchant program, the merchant can issue an electronic payment to a user's funding account. In examples, the user's funding account can correspond to the donation funding account 21.

In variations, donation funding account 21 can be associated with a mailing address that receives checks, vouchers or paper-based payment instruments (collectively “checks”) that are manually deposited with the donation funding account 21. Still further, in other variations, individual users may provide payments to donation funding account 21, based on rewards received from an affiliate marketing program. For example, the user can electronically or by postal mail forward a check that is provided to the user from an affiliate marketing partner.

Still further, in some variations, individual users may be provided credentials to allow them to make deposits directly into the donation funding account 21, using, for example, a program interface provided with or from the financial institution where the donation funding account 21 is maintained. In implementations where the user provides the payment to the donation funding account 21, the user may complete an electronic interface provided at that website for the system 100, in order to specify the amount, date of deposit and UID or account information.

### Donor Account Management

In examples, the donor account manager 120 includes processes to (i) monitor the donation funding account 21 and record deposits that correspond to affiliate program rewards paid to users of the system 100; and (ii) issue payments from the donation funding account 21 to recipients, in accordance with a payment schedule 127.

According to examples, the donor account manager 120 maintains a ledger 125 to track deposits made into the donation funding account 21. The donor account manager 120 can identify a deposit from an affiliate merchant (or user) by analyzing, for example, an account page for the donation funding account 21. In examples where deposits are received electronically by the donation funding account 21, the donor account manager 120 can obtain the remittance information by scraping an account page of the donation funding account 21 to identify account activity, including deposits and remittance information (e.g., deposit amount, deposit date, source of deposit, transaction identifier). In variations, the donor account manager 120 receives or retrieves remittance information that accompanies deposits made to the donation funding account 21. From the remittance information, the donor account manager 120 identifies the transaction identifier(s) 115 associated with each deposit. In this way, the donor account manager 120 records the transaction identifier 115 associated with each deposit with the ledger 125.

In cases where deposits are in the form of a check, an image of the check can be obtained and analyzed for remittance information such as the name of the payor/payee, check number, as well as transaction confirmation information provided on the memo line of the check. In this way, each deposit into the donation funding account 21 can be identified as to amount and source, and remittance information associated with the payment can be parsed and recorded. The amount of the deposit, the source of the payment, the date when the payment was made, and remittance information (e.g., ACH or wire payment confirmation number for electronic payment, check number and payor for check, etc.) that accompanied the deposit may be recorded with a ledger 125. In some examples, the donor account manager 120 can determine a transaction identifier 115 directly from the remittance information. In variations, the donor account manager 120 utilizes reconciliation logic 128 to identify transaction identifiers 115 for award payments received by the donation funding account 21. The reconciliation logic 128 can cross reference information retrieved from affiliate merchant sites or sources against remittance information provided with the deposit, to identify a user account identifier (e.g., name of user) and/or transaction identifiers 115. For example, an affiliate marketing partner site can identify payments made to the donation funding account 21, as well as items purchased and or account identifier is used when the purchase was made. In this way, the donor account manager 120 implements the reconciliation logic 128 to, for example, (i) itemize, by transaction, a lump payment that includes multiple reward payments from an affiliate partner, and (ii) determine a user account identifier 113 and or transaction identifier 115 for each identify transaction.

Still further in examples where the user provides or forwards the payment, the donor account manager 120 can reconcile deposits with transaction information the user provides when making the deposit or forwarding the payment.

While some examples described the donor account manager 120 as reconciling deposits received by the donation funding account 21 with transactions made by the users, in variations, agnostic reconciliation may take place. Rather, the funds received by the donation funding account 21 are subject to a payment schedule that portions or weights the total amount of the deposits received in accordance with designations or preferences of the users, or groups of users. For example, the donor account manager 120 can (i) record a total amount of deposits in a given time period, (ii) identify users that conducted transactions or otherwise utilize an affiliate marketing program of the system 100, (iii) identify payees (e.g., charitable organizations) that each of the identified users designated as a payment recipient, and (iv) allocate payment to each recipient from the donor account, based on allocations specified by the respective users. In variations, payments to individual recipients can further be allocated based on an estimate or determination of an amount of award payment that individual users are deemed to receive over a given time interval. The latter determination can be made by, for example, tracking transactions of individual users through affiliate marketing programs, as well as user input.

The donor account manager 120 can also record payments made from the donation funding account 21 to third-parties, including to organizations which are approved to receive funds from the donation funding account 21. The payments can be recorded on the ledger 125 and associated with corresponding UIDs.

The donor account manager 120 includes reconciliation logic 122 to reconcile transaction identifiers 115 associated with individual deposits with transaction identifiers 115 recorded in the transaction data store 105. Through the reconciliation process, the donor account manager 120 verifies reward amounts reflected in the transaction data store 105.

The donor account manager 120 can also interface with the donation funding account 21 to implement a payment schedule 129. The payment schedule 129 can specify dates when payee payments are to be made from the donation funding account 21. In examples, the payment schedule 129 can implement a default schedule where amounts to individual payees are paid. When payments are made from the donation funding account 21, the withdrawal is recorded in the ledger 125. The record for the withdrawal can reflect the payee (or recipient organization), as well as the user (e.g., UID 111) that received the corresponding reward payment or otherwise is to be attributed as a source for the payment to the payee.

As described with various examples, the amount issued to each payee can be based on the allocation profiles 145 of attributed deposits, where the attributed deposits are payments received from or on behalf of users, over the course of a given time interval (e.g., calendar year), and for which no prior payment has been issued against from the donation funding account 21. In some examples, the donor account manager 120 (i) aggregates the total amount of deposits made by or on behalf of individual users over a given time interval (e.g., calendar year, or quarter); (ii) calculates the amounts owed to individual payees specified through the allocation profiles 145 of the respective users; (iii) aggregates the total amounts to be paid to individual payees, and (iv) issues payment to each recipient organization in accordance with a predetermined or default payment schedule 129. The ledger 125 keeps track of payments issued from the donation funding account, so that the total amounts paid from the donation funding account 21 accurately reflects the allocation profiles 145 of the attributed deposits.

In examples, the payment schedule 129 to recipient organizations can be set by default, and independent of when corresponding deposits from users are received. In this way, the donor account manager 120 can implement optimizations, such as aggregation of payments to individual payees.

In some examples, users can specify input or preference as to when payments to a particular organization is to be made. For example, a user can specify “as soon as possible” for a given payee, meaning within a set number of days from when corresponding funds attributed to the user are received. In such examples, the user's profile can be associated with a flag that triggers an overwrite of the default payment schedule 129. For example, the donor account manager 120 can detect when a payment attributed to the user is received, record the amount in the ledger 125, check the flag value for the user and payee, and then issue an immediate payment upon determining the flag value reflects an alternative schedule.

In some examples, the donor account manager 120 can include logic to determine an alternative payment schedule for recipient organizations and/or for contributions from individual users. For example, the donor account manager 120 can identify when there is a surge of users who identify for the first time a particular recipient organization in their allocation profiles. As an addition or variation, certain recipient organizations can be preselected or identified through web site information as having time-sensitive causes. For example, the website for these organizations may use keywords such as “disaster relief fund”.

### Visual Representation of User Contributions

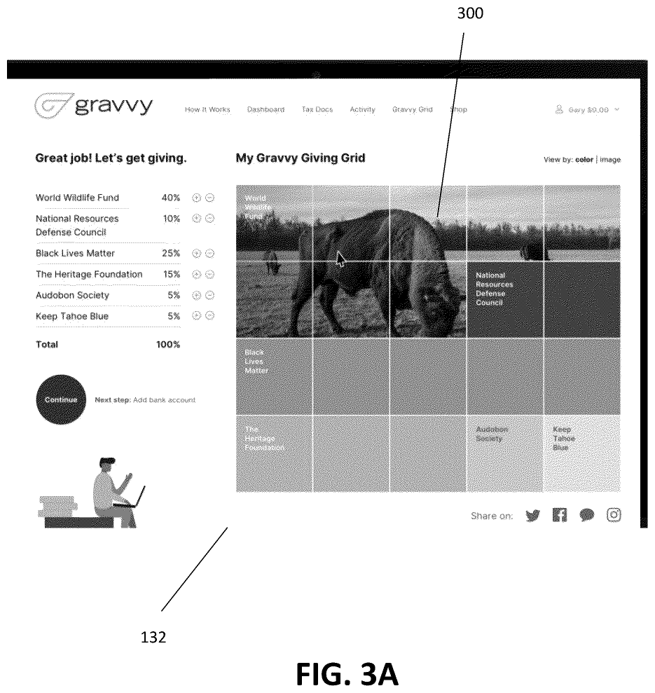

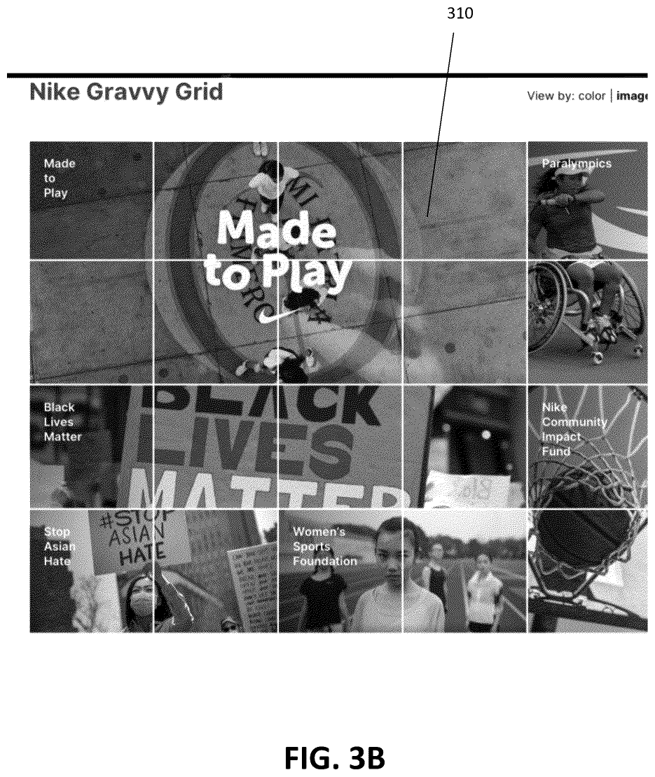

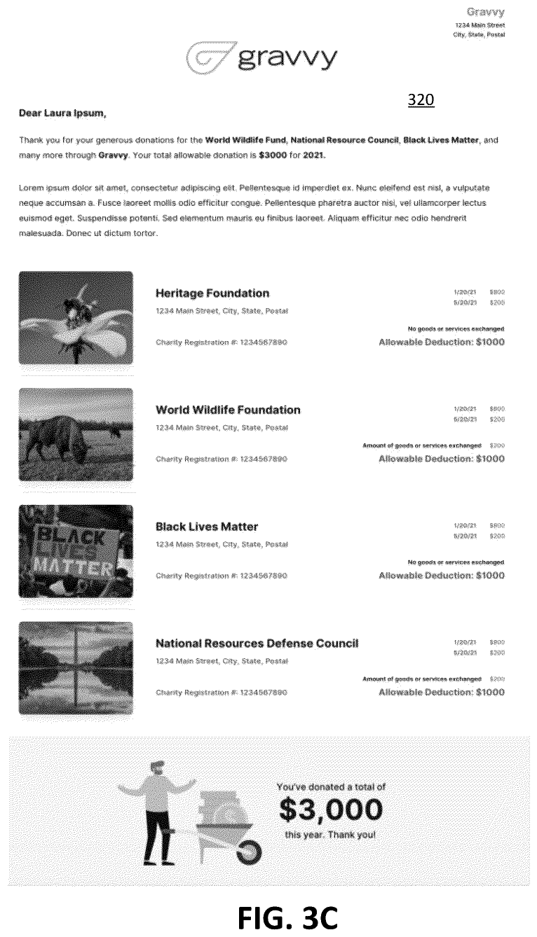

In examples, the presentation component 130 generates a presentation 132 to visually represent the user's allocation profile 145. The presentation component 130 can, for example, generate a visual representation such as shown by an example of FIG. 3, using imagery associated with the recipient organization data store 147, and based on the allocation profile 145. In some variations, the presentation 132 is user-specific and responsive to user input that alters the user's allocation profile 145. Accordingly, in some implementations, the allocation profile 145 can be dynamic, meaning the content can vary in response to predetermined conditions or events, specified by, for example, the allocation profile 144.

In examples, the presentation component 130 configures the presentation 132 based on a set of settings. By way of illustration, the settings can determine a portion of imagery that is displayed as part of the presentation 132. As an addition or variation, the settings can determine a grid position or sequence of individual images (each of which may represent a charitable organization). Further, the presentation component 130 can include a feature that enables the user to change the settings. In one implementation, the user can interact with the feature to change the settings randomly (or semi-randomly), such that the presentation 132 is reconfigured. As shown and described with an example of FIG. 3A through FIG. 3C, the presentation 132 can be in the form of a collage of images, where each image represents an organization. In a first state, the collage can be associated with a first set of settings, where the settings identify the position of individual images in the collage and/or the portions of the images that are displayed as part of the collage. When the user interacts with the feature of the presentation 132, the settings can be redetermined so that the collage is rendered in a second state. In the second state, the images of the collage are repositioned relative to other images of the collage and/or different portions of the images being displayed within the collage. In this way, the presentation component 130 can include a shuffle feature that the user can interact with to shuffle (e.g., mix, reposition, etc.) or change (e.g., re-crop) images of the presentation 132 (e.g., collage) according to a user preference and/or randomness.

In some examples, the network computer system 100 includes logic to determine a signature of the user's allocation profile 145. The signature can reflect the user's priorities with respect to charitable donations. The signature can then be used to identify products or services which the user is likely to appreciate. For example, the signature determination can match a given user to other individuals who have similar signatures. The service can identify products, services and/or contents for individuals who are matched (e.g., by signature), in order to recommend those products, services or content to the particular user.

### Allocation Profile Sharing

In embodiments, the presentation component 130 generates a shareable link 133 for the presentation 132 of the individual users. A user can access their account with the system 100 to view and share the link 133 with third-parties. For example, the user can publish their link 133 on a social networking site. Recipients of the link 133 can view the presentation 132 (or a variation that is based on the presentation 132) in order to see and appreciate the causes that a particular individual supports financially. For example, a recipient can select a shared link 133 of a given user to trigger a browser on the user's computer to display the user's presentation 132. If the recipient user is not a user of the system 100, the user can be provided an interface to initiate the registration process through registration interface 106.

If the user has registered with the system 100, the presentation component 130 can display a feature to enable the user to select some or all of the sender's allocation profile. For example, the recipient can select the feature to adopt the shared allocation profile for their own profile with the system 100. As an addition or variation, the recipient can select specific recipients identified in the sender's allocation profile, and/or specific allocations or amounts to those recipients.

### Report Generation

In examples, the system 100 includes a report generator 150 that generates a report 152 based on payments that have been made to payees specified. The report generator 150 accesses the user profile store 119 and/or the ledger 125 to generate the report 152 based on payment information 143 specified by the user.

### Donation Tracking Service

While some embodiments implement the network computer system 100 to receive user's reward payments through affiliate marketing programs, in some variations, users can donate funds from their personal account or other source to the donation funding account 21. For example, users can make payment to the donation funding account 21 as a mechanism to make payment to charitable organizations. By way of example, the user can operate an interface provided as part of the donation management service provided by the network computer system 100, to withdraw funds for the donation funding account. Through the interface, the donor account manager 120 automatically records the deposit in the ledger 125 so that it is attributed to the user.

Still further, in some examples, the network computer system 100 can include logic that can scan the accounts page of user's funding accounts (e.g., user checking account) to identify payments which the user makes to charitable organizations and recipient organizations that operate under 26 USC § 501(c)(3). The network computer system 100 can update the user's profile with respect to these types of organizations, such that the report generator 150 generates the report 152 to account for these types of donations.

### Methodology

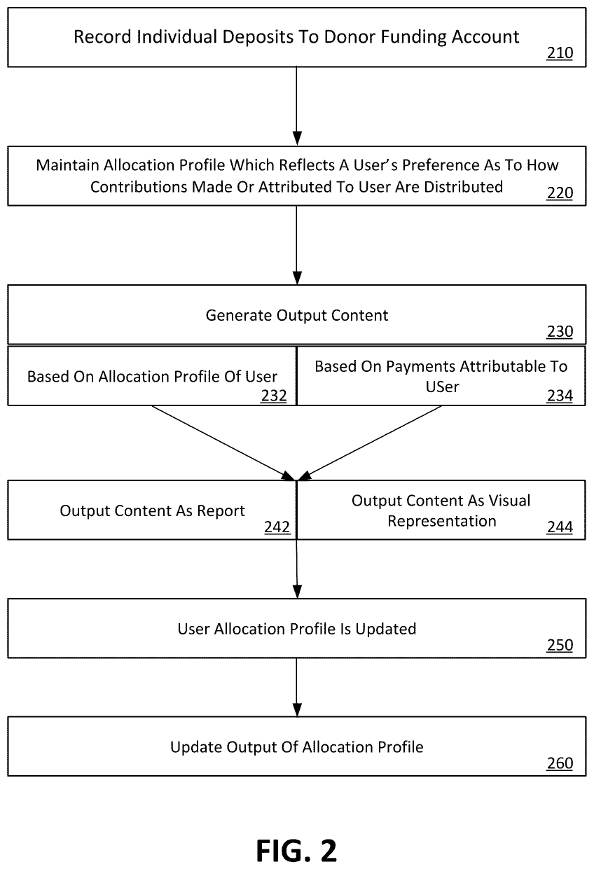

FIG. 2 illustrates a method to operate a network computer system to provide a donation management service, according to one or more embodiments. A method such as described with an example of FIG. 2 can be implemented using a network computer system such as shown with an example of FIG. 1. Accordingly, reference is made to elements of FIG. 1 for purpose of illustrating a suitable component or process for implementing a step or sub-step being described.

With reference to an example of FIG. 2, network computer system 100 operates to record deposits made by individual users to donation funding account 21 (210). Depending on implementation, the deposits can be made electronically and directly by merchants (or other third-parties), where individual deposits reflect a merchant reward made through an affiliate marketing program. In variations, the deposits of amounts into the donation funding account 21 can include manual involvement (e.g., deposits of paper checks and/or deposits by end user).

For each user, the network computer system 100 also maintains an allocation profile which reflects a user's preference as to how contributions made or attributed to the user are to be distributed (220). For example, the allocation profile 145 can identify recipient organizations, as well as a percentage or weight of the total amount which the recipient organization is to receive from the total contributions of the user to the donation funding account 21.

In examples, the network computer system 100 generates output content (230). The output content can be based at least in part on a user's allocation profile 145 with regards to contributions (232). As an addition or variation, the network computer system 100 generates the output content based on amounts attributed to the user in the ledger 125 as having been paid to specific recipients, over a given interval of time (234). Thus, for example, the output can be generated in a form that itemizes distributions made to recipient organizations on behalf of the user (e.g., based on payments to the ledger 125), as well as distributions which are to be made at a later date (e.g., based on the allocation profile 145 of the user).

In some examples, the output can be in the form of a report, such as a document which identifies the recipient organizations and the amounts which have or will be paid to each organization (240). In some applications, the document can be prepared as a prepopulated letter that is suitable for a tax authority (e.g., IRS).

As an addition or variation, the output can be in the form of a visual representation of the allocation profile (242). The visual representation can reflect the recipient organizations, the allocation and/or the priority of the particular organization to a given user. In some implementations such as shown by FIG. 3, the visual representation can be in the form of a collage, based on imagery that is associated with the individual recipient organizations of a given user's allocation profile.

The user can modify or update their allocation profile at any time (250). For example, the user can provide input to add a new recipient and/or to change the allocation of recipient organizations. In variations, the user can adopt in whole or in part the allocation profile of another user. For example, a user (e.g., individual or entity) can publish a visual representation of their allocation profile, using, for example, a shared link. The presentation component 130 can receive and process the shared link, to enable the visual representation of the shared link to be viewed. Further, the presentation component 130 can provide an input feature to enable the user to add some or all of the allocation profile of the shared link to the user's own allocation profile. As an illustration, the visual representation can identify four recipient organizations that have equal allocations of 25%. The user can view the visual representation of the shared link and elect to adopt the allocation of the shared link for a specific percentage of the user's total allocation. As an illustrative example, the user can elect to adopt the allocation profile of the shared link for 50% of the user's total allocation. Alternatively, the user can simply adopt the shared allocation in its entirety for the user's own allocation profile, in which case the user's allocation profile is replaced with that of the shared allocation profile.

In response to a user updating or changing their allocation profile, the output reflecting the user's allocation profile can change (260). For example, the report can change as to the recipients and amounts which each recipient is to receive (or has received). Likewise, the visual representation can also change to reflect the changes to the user's allocation profile.

FIG. 3A through FIG. 3C illustrate examples of output content which can be generated by network computer system 100, according to one or more examples. In describing examples of FIG. 3A through FIG. 3C, reference is made to elements of FIG. 1 for purpose of illustrating suitable components for generating an output or implementing functionality as described.

With reference to FIG. 3A, an example visual representation of a payment distribution is shown, according to one or more embodiments. In examples, the visual representation can be rendered as part of a presentation 132 provided through the presentation component 130 of network computer system 100. A user can render the visual representation on, for example, a mobile device or display component of the user-operated computing device. As shown, in some examples, the visual representation 300 can be in the form of a collage, with imagery that comprises elements of the collage being based on imagery retained in the recipient organization data store 147. The imagery of the visual representation 300 can thus reflect the allocation profile 145 of the user.

In examples, the presentation component 130 can generate a link that enables the user to share the visual representation 300. For example, the visual representation 300 can be shared on a social network page, through messaging applications or on other mediums.

Further, in some examples, the visual representation 300 can be formed to be interactive, to enable other users of the system 100 to view the recipient organizations of the user's charitable allocations, as well as the allocation profile 145 of the user. For example, each element of the collage can be selectable to enable a third-party (e.g., recipient of the shared link) to view information about the recipient organization, as well as the user (sharer of link) donation amount.

FIG. 3B illustrates a sponsored or branded visual representation, according to one or more examples. A user of network computer system 100 can include a corporate user, and the allocation profile for the corporate user can associate branded imagery with recipient organizations. As with other examples, the visual representation 2310 can reflect an allocation profile, or alternatively, a priority for charitable donations, reflecting the values of the user. The imagery can include those identified for the recipient organization combined with user-selected (e.g., corporate sponsored imagery and branding) images. In this way, the visual representation 310 can cobrand or give corporate sponsorship to particular causes or organizations. In examples, the visual representation 310 can be published to other users in various mediums. Additionally, the visual representation 310 or elements thereof may be selectable to enable individuals to view information about the recipient organizations, and/or to adjust or modify their allocation profile to integrate in whole or in part the allocation profile of the corporate user.

FIG. 3C illustrates a report that can be generated by network computer system 100, according to one or more embodiments. A report 320 can be generated by, for example, report generator 150. In examples, the report can combine template content with information retrieved about recipient organizations of the user's allocation profile. As an addition or variation, the report can include information retrieved about recipient organizations who received payments attributable to the user, based on information recorded with the recipient organization data store 147. As shown, the report 320 displays information about each recipient, as well as the amount each recipient received or is scheduled to receive. As an addition or variation, the report 320 include imagery associated with the particular recipients. In examples, the report 320 is dynamic, meaning that the contents of the report can change based on the user changing or updating the allocation profile 145.

### Hardware Description

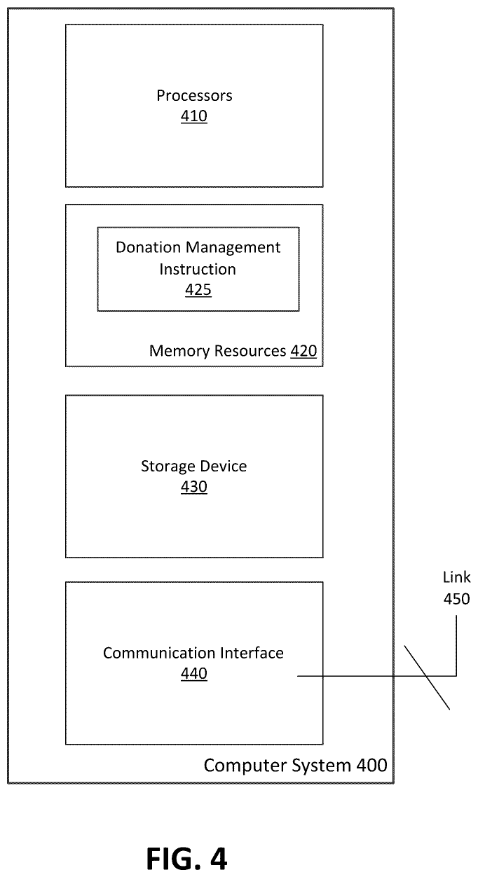

FIG. 4 illustrates a block diagram for a computer system on which examples described herein may be implemented. For example, in the context of FIG. 1, network computer system 100 may be implemented using a computer system or combination of computer systems such as described by FIG. 4.

In one implementation, the computer system 400 includes one or more processors 410, memory resources 420, and a communication interface 430. The computer system 400 includes at least one processor 410 for processing information. The memory resources 420 may include a random access memory (RAM) or other dynamic storage device, for storing information and instructions to be executed by the processor(s) 410. The memory resources 420 also may be used for storing temporary variables or other intermediate information during execution of instructions to be executed by the processor(s) 410. The computer system 400 may also include other forms of memory resources, such as static storage devices for storing static information and instructions for the processor 410. The memory resources 420 can store information and instructions, including instructions 425 for implementing a donation management service such as described with an example of FIG. 2.

The communication interface 430 can enable the computer system 400 to communicate with one or more networks 480 (e.g., cellular network) through use of the network link (wireless or wireline). Using the network link, the computer system 400 can communicate with one or more other computing devices and/or one or more other servers or data centers. In some variations, the computer system 400 can receive device data and/or service-specific information from devices, portals or other interfaces using a network link 450.

Examples described herein are related to the use of the computer system 400 for implementing the techniques described herein. According to one embodiment, those techniques are performed by the computer system 400 in response to the processor 410 executing one or more sequences of one or more instructions contained in the memory resource 420. Such instructions may be read into the memory resources 420 from another machine-readable medium, such as the storage device. Execution of the sequences of instructions contained in the memory resources 420 causes the processor 410 to perform operations and steps, as described herein. In alternative implementations, hard-wired circuitry may be used in place of or in combination with software instructions to implement examples described herein. Thus, the examples described are not limited to any specific combination of hardware circuitry and software.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A network computer system comprising:
one or more processors;
a memory to store a set of instructions;
wherein the one or more processors execute the set of instructions to perform operations that include:
for each user of a plurality of users, recording one or more deposits for a donation funding account that is shared amongst the plurality of users, the donation funding account including a total fund that is based on the recorded deposits for the plurality of users;
maintaining an allocation profile for each user of the plurality of users, the allocation profile identifying one or more user-selected recipients and an allocation of a portion of the total fund that is attributable to the user for each of the one or more recipients; and
in response to a report event for a given user of the plurality of users, automatically generating a donation acknowledgment report that identifies a distribution of the portion of the fund that is attributable to the user for each of the one or more recipients, the identified distribution being based on the allocation profile of the user.
